(19) United States
(12) Patent Application Publication
(10) Pub. No.: US 2010/0288058 A1
(43) Pub. Date: Nov. 18, 2010

(54) PIPETTE BODY, PIPETTE TIP AND METHOD

(75) Inventor: Juha Laiho, Kangasala (FI)

Correspondence Address: COHEN, PONTANI, LIEBERMAN & PAVANE LLP, 551 FIFTH AVENUE, SUITE 1210, NEW YORK, NY, 10176, US

(73) Assignee: Medisize Oy, Vantaa (FI)

(21) Appl. No.: 12/735,138

(22) PCT Filed: Dec. 16, 2008
(86) PCT No.: PCT/FI2008/050745

§ 371 Date: Jun. 17, 2010

(30) Foreign Application Priority Data
Dec. 21, 2007 (FI) 20075955

(51) Int. Cl. B01L 3/02

(52) U.S. Cl. 73/864.01

(57) ABSTRACT

Pipette tip, pipette body and method for analysis. The pipette tip (1) comprises a tip body (6) having an inner surface (I) and an outer surface (O). The tip body comprises a first end (3) and a second end (4) having a flow opening (19). The tip body (6) is provided with a first optical grating structure (7) arranged to conduct light away from the tip body to the side of the inner surface (I). The tip body is provided with a receiving grating structure (8) arranged to receive light conducted away from the tip body through the first optical grating structure. The first end (3) comprises a light-receiving surface (9) optically connected through the tip body to the first optical grating structure. The first end (3) comprises a surface (10) that conducts light away and is optically connected through the tip body to said receiving optical grating structure (8).

### BACKGROUND OF THE INVENTION

The invention relates to a pipette tip comprising a tip body having an inner surface and an outer surface, the tip body further comprising a first end having means for fastening the pipette tip to the pipette body, and a second end having a flow opening for transferring running substances into the pipette tip and out of the pipette tip.

The invention further relates to a pipette body comprising fastening means for fastening at least one pipette tip, and means for generating a negative and/or a positive pressure inside the pipette tip fastened to the pipette body.

The invention also relates to a method for analysis.

A pipette is an instrument to be used for transfer and accurate dosage of substances in laboratory work. For more demanding purposes, mechanical or electrical dosimeters, i.e. pipette bodies, are used, to which disposable pipette tips are fastened. Said pipette bodies comprise means for generating a negative and a positive pressure in the pipette tip.

The pipette tip is typically manufactured from a thermoplastic material by injection molding. Accurate dimensions, surface shapes and the surface energy of the material constitute a strategic combination as regards a dosage event. The overall accuracy of the dosage event is dependent on the interaction of the pipette body and the pipette tip. In the usage event, the attempt is to minimize the effect of the user on the accuracy of the pipetting.

Although a sufficient accuracy in measuring the amount of substance is generally achieved in pipetting, this is not always the case. The accuracy and reproducibility of the operations of the pipet body part can be developed to a high level, but the characteristics and operation of the pipette tip part restrict the accuracy of the pipetting in some cases.

### BRIEF DESCRIPTION OF THE INVENTION

The object of the present invention is to provide a new and improved pipette body, pipette tip and a method for achieving a pipetting event that is more accurate than previously.

The pipette tip of the invention is characterized in that the tip body is provided with a first optical grating structure arranged to conduct light away from the tip body to the side of the inner surface thereof, that the tip body is provided with a receiving grating structure arranged to receive the light conducted away from the tip body through the first optical grating structure, that said first end comprises a light-receiving surface optically connected through the tip body to the first optical grating structure, and that said first end comprises a surface that conducts light away and is optically connected through the tip body to said receiving optical grating structure.

The pipette body of the invention is characterized in that light generating means and means for directing said light to the pipette tip body are arranged in the pipette body.

The method of the invention is characterized by filling a pipette tip with a substance to be analyzed, generating light in the pipette, conducting said light through a first optical grating structure arranged in the pipette tip to the substance to be analyzed and contained in the pipette tip, receiving light that has interacted with the substance to be analyzed with a receiving grating structure, conducting the light received by the receiving grating structure to an optoelectronic element arranged in the pipette, and generating an electrical signal proportional to the light in the optoelectronic element.

The idea of the invention is to integrate means into the pipette tip for conducting light to and from a substance to be pipetted, and to arrange means in the pipette body for generating said light and for converting it to an electrical signal usable in a quantitative and/or a qualitative analysis of the substance to be pipetted. In an embodiment, the light conducted through the grating structure is used for monitoring a change in the interface between a gaseous medium inside the pipette tip, such as air, and a running substance to be pipetted. This allows information to be obtained about changes in the height of the liquid level and, furthermore, about changes in the liquid volume.

An advantage of the invention is that the substance to be pipetted can be measured directly and not indirectly by means of elements moving in the pipette body. A further advantage is that the qualitative characteristics of the substance to be pipetted can be measured right at the pipette tip.

The idea of an embodiment of the invention is to integrate the receiving grating structure into the first optical grating structure. The advantage is a reduction in the number of grating structures required.

The idea of another embodiment of the invention is that the grating structures are coated with a transparent coating. The advantage is a reduction in the risk of damage to the grating structures,

### BRIEF DESCRIPTION OF THE FIGURES

Some embodiments of the invention will be described in more detail in the accompanying drawings, wherein

FIG. 1 schematically shows a pipette comprising a pipette tip and a pipette body of the invention,

FIG. 2 schematically shows another pipette comprising a pipette tip and a pipette body of the invention,

FIG. 3 schematically shows a sectional side view of a pipette tip according to the invention,

FIG. 4 schematically shows a sectional side view of a detail of a pipette tip according to a second embodiment of the invention,

FIG. 5 schematically shows a sectional side view of a detail of a pipette tip according to a third embodiment of the invention, and

FIG. 6 schematically shows a side view of a pipette tip according to a fourth embodiment of the invention.

In the figures, some embodiments of the invention are shown in a simplified manner for the sake of clarity. In the figures, like parts are denoted by like reference numbers.

### DETAILED DESCRIPTION OF THE INVENTION

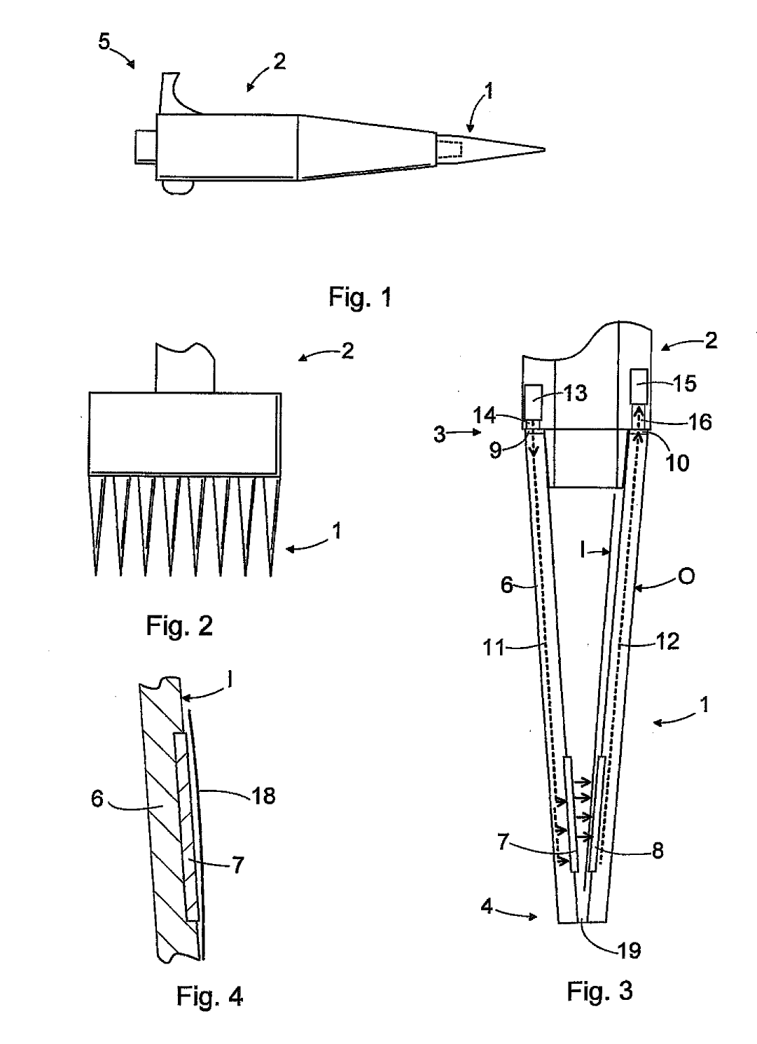

FIG. 1 schematically shows a pipette comprising a pipette tip 1 and a pipette body 2 of the invention. The pipette body 2 comprises fastening means to which one pipette tip 1 at a time can be detachably fastened. The pipette tip 1 is typically disposable and made of a thermoplastic material by injection molding.

The pipette body 2 also comprises means, known per se, for generating a negative and/or a positive pressure inside the pipette tip 1 fastened to the pipette body. Furthermore, the pipette body comprises operating means 5 by means of which a user of the pipette uses the pipette. The most typical measures controlled with the operating means 5 include adjustment measures associated with the dosage volume and the generation of the above-mentioned negative and/or positive pressure. The operating means 5 may be implemented mechanically or electrically or as a combination thereof.

FIG. 2 schematically shows another pipette comprising a pipette tip and a pipette body according to the invention. The pipette body 2 comprises fastening means for the simultaneous fastening of a plurality of pipette tips 1, in this case eight.

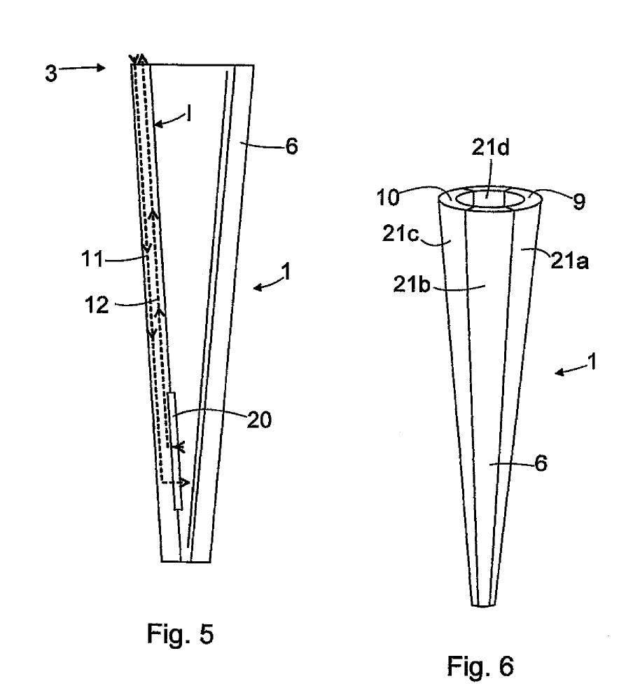

FIG. 3 schematically shows a sectional side view of a pipette tip according to the invention. The pipette tip 1 comprises a tip body 6 provided with an inner surface 1 and an outer surface O. Let it be mentioned in this connection that both FIG. 3 and FIG. 5 differ from a customary sectional view in that the sectional surfaces are shown without diagonal lines for clarifying the explanation of the subject matter.

The pipette tip 1 comprises a first end 3 provided with means for fastening the pipette tip 1 to the pipette body 2, and a second end 4 provided with a flow opening 19 for transferring substances in liquid form into the pipette tip 1 and out of the pipette tip 1—depending on the magnitude of the pressure generated inside the pipette tip 1.

The pipette tip body 6 is provided with a first optical grating structure 7. This is arranged to conduct light 11 coming along the pipette tip body 6 to said grating structure 7 out of the pipette tip body 6 to the side of the inner surface I thereof. The first optical grating structure 7 is an optical grating known per se, whose operation is based on a surface structure in the order of micrometers or nanometers.

The pipette tip body 6 is also provided with a receiving grating structure 8. This receives light conducted out of the pipette tip body 6 via the optical grating structure 7.

The first end 3 of the pipette tip comprises a light-receiving surface 9 optically connected through the pipette tip body 6 to the first optical grating structure 7. An optical connection naturally requires that the pipette tip body 6 is at least partly made from said transparent material such that an optical connection or channel is arranged between the receiving surface 9 and the first optical grating structure 7.

The first end 3 of the pipette tip also comprises a surface 10 that conducts light away and is optically connected through the pipette tip body 6 to said receiving optical grating structure 8. The receiving optical grating structure is an optical grating, known per se, whose operation is based on a diffractive surface structure in the order of micrometers or nanometers.

Both the receiving surface 9 and the surface 10 that conducts light away are preferably part of the surface of the first end 3, which may be e.g. ground, polished or, optionally, shaped into an optically advantageous shape that accumulates, disperses or otherwise controls light. Said surfaces 9, 10 may be designed and manufactured in such a manner that the losses occurring in connection therewith are as small as possible, however, in such a manner that the operation of the connection is adapted to the requirements set on the connection. In this case, normal arrangements and design instructions, known per se and intended for connecting light guides are used.

The pipette body part 2 is provided with a transmitter component 13 generating—visible light or a given wavelength range thereof in this case—and optionally also an element 14 that controls and directs the light produced by the transmitter component 13 and guides said light to the receiving surface 9. The incoming light 11 propagates to the first grating structure 7 in the pipette tip body 6. Accordingly, the pipette tip body 6 serves as a light guide. To simplify the presentation of this feature, FIG. 3 shows incoming and departing light 11, 12 by straight arrows. However, this does not mean that the light could not propagate for example by reflection at the inner surface I and the outer surface O of the tip body 6.

The first grating structure 7 is arranged to conduct incoming light 11 away from the body 6 to the side of the inner surface I thereof. As was stated above, the first grating structure 7 is a structure known per se, and is not dealt with in more detail in the present description.

The light 11 conducted out of the pipette tip body 6 to the side of the inner surface I thereof comes into interaction with one or more substances in the pipette tip 1. Said substance may be a substance to be pipetted or a substance present in the pipette tip but not intended to be pipetted. Said interaction changes some characteristic of the light, such as, for instance, the intensity or the wavelength distribution or the refractive index observed on the inner surface I.

Having passed through the substance to be pipetted, the light or at least an essential part thereof ends up in the receiving grating structure 8 arranged in the pipette tip essentially on the other side of the inner surface I of the pipette tip body relative to the first grating structure 7.

From the light coming thereto and having interacted with the substance, the receiving grid structure 8 generates returning light 12. This propagates in the pipette tip body 6 serving as a light guide to the surface 10 that conducts light away and from there further out of the pipette tip 1.

The surface 10 that conducts light away directs the returning light 12 into a second light-controlling and light-directing element 16 contained in the pipette body 2. Said element 16, which is by no means necessary, directs light to an optoelectronic element 15.

The optoelectronic element 15 is arranged to convert light into an electrical signal from which the changes caused by the substance to be pipetted to the intensity, wavelength or wavelength distribution of the light, for example, can be read by suitable analytical methods. Said changes express given quantitative and/or qualitative magnitudes descriptive of the substance to be pipetted. This allows versatile information to be obtained about the flow volume, for example, enabling the implementation of feedback for ensuring an accurate dosage of the liquid volume. Furthermore, information about the viscosity, changes in color, flow rate, dry matter content of the liquid, for example, may be obtained.

FIG. 4 schematically shows a sectional side view of a detail of a pipette tip according to a second embodiment of the invention. The first grating structure 7 is arranged on the side of the inner surface I of the pipette tip body 6. The grating structure 7 is coated with a transparent protective coating 18. The protective coating 18 is shown detached from the grating structure 7 and the body 6 in order to clarify the matter. In reality, the protective coating 18 is fixed to the grating structure 7. In some embodiments, the protective coating 18 covers substantially the entire area of the inner surface I of the pipette tip body. The protective coating 18 protects the fragile grating structure 7. It is evident that all grating structures arranged in the pipette tip may be protected with one or more protective coatings 18. The protective coating 18 may be manufactured by thin-film manufacturing methods, known per se, such as by various additive processes, by injecting, by spraying, by a dipping method etc. or by injection molding, for example. The protective coating 18 may comprise one or more layers.

FIG. 5 schematically shows a sectional side view of a detail of a pipette tip 1 according to a third embodiment of the invention. Herein, the receiving grating structure is integrated into the first optical grating structure such that a combination grating structure 20 is generated.

The incoming light 11 propagates in the pipette tip body 6, serving as a conductor, into the combination grating structure 20, from where it is guided to the substance to be pipetted on the side of the inner surface I of the body. Part of the light interacting with the substance to be pipetted is reflected back to the combination grating structure 20. Reflective index changes in the inner surface of the pipet tip 1 may also be detected. The combination grating structure 20 converts back-reflected light into returning light 12 that propagates to the first end 3 of the tip and further therefrom out for analysis. An advantage of the solution is that it is enough to prepare one grating structure in the pipette tip 1 in place of two grating structures. Let it be mentioned in this connection, that the pipette tip 1 may be provided with one, two or more first grating structures 7, receiving grating structures 8 or combination grating structures 20. The grating structures 7, 8, 20 maybe arranged for instance along the length of the pipette tip 1, allowing the substance to be pipetted and located at different points of the pipette tip 1 to be measured through them. A separate light guide channel may be connected to each first grating structure 7 and receiving grating structure 8 or combination grating structure 20, respectively, for instance in accordance with the principle shown in FIG. 6.

Thus, in the method of the invention, the pipette tip 1 is filled with the substance to be pipetted, i.e. analyzed. The substance to be analyzed is in liquid form, being e.g. a liquid, a gas, an aerosol, a gel, a suspension, an emulsion, foam or sol.

The transmitter component 13 arranged in the pipette generates light that is transferred through the pipette tip body 6 into the substance to be analyzed contained in the pipette tip. The transmitter component 13 may be e.g. a LED (Light Emitting Diode) that produces a wave movement at the wavelength of mainly or entirely visible light. Alternatively, the transmitter component 13 may produce for instance light at least mainly at the infrared or ultraviolet range or a given waveband thereof.

The pipette tip body 6 is provided with the first optical grating structure 7 that controls the light propagating in the body 6 into the substance to be pipetted.

The light interacts with the substance to be pipetted, and the light in said interaction is guided through the receiving optical grating structure 8 and, conveyed by the pipette tip body 6, into the optoelectronic element 15, known per se, in the pipette.

The optoelectronic element 15 transmits an electrical signal that is proportional to the light incoming to it. Said electrical signal can be analyzed for determining at least some quantitative or qualitative characteristics of the substance to be pipetted.

FIG. 6 schematically shows a side view of a pipette tip according to a fourth embodiment of the invention. The pipette tip body 6 is manufactured from two materials constituting four material zones in the longitudinal direction of the pipette tip 1. The first and third material zones 21a, 21c are manufactured from a material serving as a conductor for the light to be conducted through the pipette tip 1. The grating structures, which are on the inner surface of the pipette tip, are arranged on the first and third material zones 21a, 21c, as are also the receiving surface 9 and the surface 10 that conducts light away.

The second and fourth material zones 21b, 21d are manufactured from a material that does not conduct the light to be conducted through the pipette tip 1. Accordingly, the second and fourth material zones 21b, 21d serve as insulation layers isolating incoming and departing light into their own conductive channels. In some cases, this may help in making analyses that are more accurate.

The pipette tip 1 may be manufactured by an injection molding technique, known per se. The mold only has to be provided with surface structures required for generating the grating structures 7, 8, 20. Other processes, known per se, for manufacturing optical grating structures and light guides may also be used, such as for instance hot embossing, engraving, insertion, printing processes, IMD or IML membranes, etc.

In some cases, the characteristics disclosed in the present application may be used as such, irrespective of other characteristics. On the other hand, characteristics disclosed in the present application may be combined to generate various combinations.

The drawings and the related description are only intended to illustrate the idea of the invention. The details of the invention may vary within the scope of the claims.

1-16. (canceled)

17. A pipette tip comprising a tip body having an inner surface and an outer surface, the tip body further comprising:
a first end having means for fastening the pipette tip to the pipette body; and
a second end having a flow opening for transferring running substances into the pipette tip and out of the pipette tip, wherein:
the tip body is provided with a first optical grating structure arranged to conduct light away from the tip body to the side of the inner surface thereof;
the tip body is further provided with a receiving grating structure arranged to receive the light conducted away from the tip body through the first optical grating structure; and
said first end being arranged to comprise a light-receiving surface optically connected through the tip body to the first optical grating structure and a surface that conducts light away and is optically connected through the tip body to said receiving optical grating structure.

18. The pipette tip as claimed in claim 17, wherein the light is visible light.

19. The pipette tip as claimed in claim 17, wherein the light is infrared light.

20. The pipette tip as claimed in claim 17, wherein the light is ultraviolet light.

21. The pipette tip as claimed in claim 17, wherein the receiving grating structure is integrated into the first optical grating structure.

22. The pipette tip as claimed in claim 17, wherein the receiving grating structure is arranged separately from the first optical grating structure and substantially on the opposite side of the inner surface with respect thereto.

23. A pipette tip as claimed in claim 17, wherein the grating structures are coated with a transparent coating.

24. The pipette tip as claimed in claim 17, further comprising light-conducting material zones and non-light-conducting material zones.

25. The pipette tip as claimed in claim 17, said pipette tip being manufactured of a polymer material.

26. The pipette tip as claimed in claim 17, wherein said pipette tip is a disposable pipette tip.

27. A pipette body comprising an end for fastening at least one pipette tip; and
a transmitter component arranged to generate light directed to said pipette tip.

28. The pipette body as claimed in claim 27, wherein the transmitter component is a light source producing at least mainly visible light.

29. The pipette body as claimed in claim 27, wherein the transmitter component is a light source producing at least mainly infrared light.

30. The pipette body as claimed in claim 27, wherein the transmitter component is a light source producing at least mainly ultraviolet light.

31. The pipette body as claimed in claim 27, comprising an optoelectronic element arranged to convert light into an electronic signal, the light being generated by said transmitter component and directed at the pipette tip.

32. A method for analysis, comprising steps of:
filling a pipette tip with a substance to be analyzed;
generating light in the pipette;
conducting said light through a first optical grating structure arranged in the pipette tip to the substance to be analyzed and contained in the pipette tip;
receiving light that has interacted with the substance to be analyzed with a receiving grating structure;
conducting the light received by the receiving grating structure to an optoelectronic element arranged in the pipette; and
generating an electrical signal proportional to the light in the optoelectronic element.
